(19) United States
(12) Patent Application Publication
(10) Pub. No.: US 2017/0262929 A1
(43) Pub. Date: Sep. 14, 2017

(54) DRIVE-THROUGH MERCHANDISE PICK-UP SYSTEM AND METHOD

(71) Applicant: Underside s.p.r.I., Le Roeulx (BE)

(72) Inventor: Christophe Degraeve, Le Roeulx (BE)

(73) Assignee: Underside s.p.r.I., Le Roeulx (BE)

(21) Appl. No.: 15/063,802

(22) Filed: Mar. 8, 2016

(51) Int. Cl. G06Q 30/06; G06Q 30/02

(52) U.S. Cl. CPC G06Q 30/0635; G06Q 30/0281

(57) ABSTRACT

A drive-through type pick-up system comprising a physical drive-through type facility for storing supplier or reseller goods that are scheduled to be picked-up by a customer with a corresponding purchase order, a detection system capable of detecting when the customer is within a pre-defined range of the physical drive-through type facility and of transmitting notification that the customer has been detected within the pre-defined range, a data system capable of storing and retrieving customer data, purchase order data and drive-through facility performance data and a communication system capable of providing for communication between an employee of the drive-thought facility and the detected customer and of providing for a flow of data to and from the data system.

### FIELD OF THE INVENTION

This disclosure relates generally to a system and method for efficient merchandise pick-up. More specifically, this disclosure relates to a drive-through facility that partially or completely automates the preparation of existing purchase orders for pick-up by customers at a physical location. The partial or complete automation is based on the geolocation and estimated arrival time of a customer travelling to a drive-through facility to fulfill an order. This information allows a retailor operating the drive-through facility to optimize the preparation and delivery of a purchase order based on knowledge of a customer's arrival time at the drive-through facility.

### BACKGROUND

The most common problems associated with present-day drive-through facilities include a disorganized or unoptimized pick-up operation resulting in long wait times for the customer and a lack of personalized customer service. As a result, customers arriving at a drive-through traditionally have substantial wait times as a result of generally disorganized order fulfillment processes. Moreover, customers are more likely to feel like a number rather than a valued customer precluding, the creation of any emotional bonds with the retailer. Employees and owners of a drive-through facility seldom have information on a customer prior to their arrival or on their actual arrival time that are necessary to solve these problems.

### BRIEF SUMMARY

As a solution to the above described problems and needs, the present invention. discloses an embodiment of a drive-through type pick-up system comprising a physical drive-through type facility for storing supplier or reseller goods that are scheduled to be picked-up by a customer with a corresponding purchase order, a detection system capable of detecting when the customer is within a pre-defined range of the physical drive-through type facility and of transmitting notification that the customer has been detected within the pre-defined range, a data system capable of storing and retrieving customer data, purchase order data and drive-through facility performance data, and a communication system capable of providing for communication between an employee of the drive-thought facility and the detected customer and of providing for a flow of data to and from the data system.

In a further embodiment, the communication system includes any one or any combination of a low energy beacon device, a global positioning system and a license plate scanning device.

In a further embodiment, the drive-through type pick-up system also includes a smartphone type device accompanying the customer, the smartphone type device implementing a customer application which enables remote communication between the customer and the communication system and a computing type device accompanying the employee, the computing type device implementing an employee application that enables communication between the employee and the communication system.

In a further embodiment, the detection system estimates an arrival time for the customer detected to be within the pre-defined range of the physical drive-through type facility and the communication system providing the arrival time for the customer to the employee.

In a further embodiment, the detection system calculates a waiting time for the customer detected to be within the pre-defined range of the physical drive-through type facility, the waiting time calculated as a time difference between a current time and the estimated arrival time.

In a further embodiment, the employee application prioritizes customers within a customer queue displayed on the employee computing device based on the calculated waiting time.

In a further embodiment, the data system generates personalized pick-up instructions for the detected customer and the communication systems transmits the personalized pick-up instructions to the customer application which then displays the personalized pick-up instructions on the detected customer's smartphone.

In a further embodiment, the customer application provides for a customer to manually announce their presence to the detection system.

In a further embodiment, the customer application transits to the communication system identification information and purchase order information inputted by the detected customer.

### BRIEF DESCRIPTION OF THE DRAWINGS

This disclosure is further described in the detailed description that follows, with reference to the drawings, in which:

FIG. 1 is a block diagram of the drive-through merchandise pick-up system according to an exemplary embodiment of the present invention.

FIG. 2 is a flowchart depicting a customer centric process implemented by the drive-through merchandise pick-up system according to an exemplary embodiment of the present invention.

FIG. 3 is a flowchart depicting a retailer centric process implemented by the drive-through merchandise pick-up system according to an exemplary embodiment of the present invention.

### DETAILED DESCRIPTION

As discussed above, an exemplary embodiment of a drive-through merchandise pick-up system is disclosed. As required, detailed embodiments of the present invention are disclosed herein; however, it is to be understood that the disclosed embodiments are merely exemplary of the invention that may be embodied in various and alternative forms. The figures are not necessarily to scale and some features may be exaggerated or minimized to show details of particular components. Therefore the structural and functional details disclosed herein are not to be interpreted as limiting, but merely as a representative basis for teaching one skilled in the art to variously employ the present invention.

In order to solve the above-described problems associated with preset-day drive-through facilities, the present invention implements a system and method that notifies the drive-through facility of a customer's impending or actual arrival at the drive-through facility. The system further provides for the transmission of customer information to the drive-through facility and for the transition of personalized pick-up instructions to the arriving customer in an effort to facilitate and optimize the processes involved in the pick-up of goods or services at eth drive-through facility.

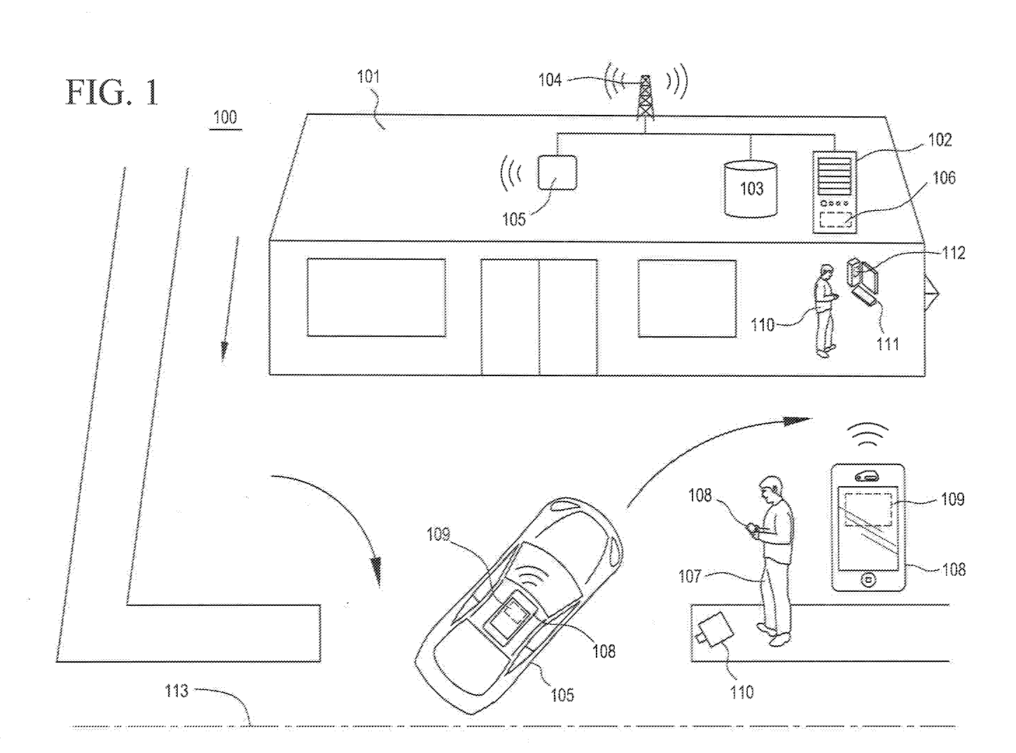

In FIG. 1, a block diagram of the drive-through merchandise pick-up system according to an exemplary embodiment is depicted. As shown in FIG. 1, the drive-through merchandise pick-up system 100 includes a brick and motor drive-through facility 101 at a location capable of accommodating interaction with both motorized vehicles 106 and foot traffic 107 The drive-through facility 101 includes a central server 102, a data system 103, a communication system 104 and a detection system 105.

The central server 102 implements general computing processing and data analysis as well as implement a retailer application 106. The general computing and data analysis including processing data necessary to facilitate the processes necessary to implement the pick-up of merchandise from the drive-through facility 101.

The data system 103 stores and retrieves all data necessary to facilitate the processes necessary to implement the pick-up of merchandise from the drive-through facility, the data system 102 may include at least any database systems known to one of relative skill in the art. The data system 102 is accessed by the central server 105 via local area network 106 type of connection.

The communication system 104 allows for wireless communication between the drive-through facility 101 and employees 110 of the drive-through facility 101 and between the drive-through facility 101 and customers 106, 107 in-route or that have already arrived at the drive-through facility 101. The connection system 104 may implement a local wireless network as well as a wireless connection to the Internet or other remote networks.

The detection system 105 detects customers which are within a pre-defined range 1,13 of the drive-through facility 101. The detection system 105 may implement any technology known to one of reasonable skill in the art including a low energy beacon device. The beacon broadcasts a universally unique identifier and ancillary data that are received by a smartphone type device 108 carried by a customer 106, 107 within the pre-defined range 107 of the drive-through facility 101. The identifier and ancillary data are used to determine and validate the immediate proximity of a customer to the drive-through facility 101 and to trigger a check-in type of task performed by a customer application 109 implemented on the customer's smartphone device 108 and in coordination with the retail application 106 implemented on the central server 102.

The detection system 105 may also including interfacing with a global positioning system (GPS) system in cooperation with the smartphone type device 108. The use of GPS provides for determining if a customer 106, 107 not yet within the pre-defined range 113 of the drive-through facility 101 is actually on route to that drive-through facility 101. Moreover, use GPS provides for an estimate of the customer's 106, 107 actual arrival time at the drive-through facility 101.

Employees 110 of the drive-through facility 101 communicate with the drive-through merchandise pick-up system 100 using a computing type device 111 on which is implemented an employee application 112. Customers communicate with the drive-through facility 101 using the smartphone type device 108 on which is implemented the customer application 109. The smartphone device 108 may include any device of similar functionality as known to one of reasonable skill in the art including a smartwatch, a tablet or any other device capable of wireless communication and of implementing the customer application 109. The drive-through merchandise pick-up system 100 may further include a license plate scanning device 110 capable of scanning the license plates of motor vehicles approaching the drive-through facility 101 and of transmitting license plate information to the central server 102 via the communication system 104.

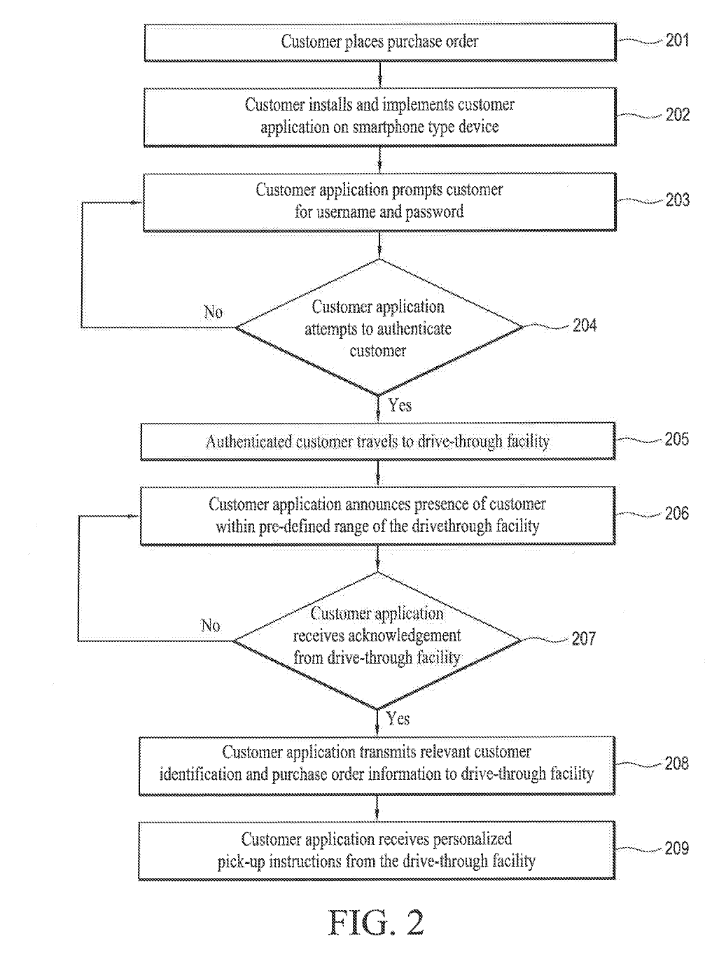

In FIG. 2, a flowchart depicting a customer centric process performed within the drive-through merchandise pick-up system is shown. As shown in FIG. 2, a customer initiates the process in step 201 by placing a purchase order for goods or services which the customer will pick-up at a drive-through facility. The purchase order may be placed in any form know to one of reasonable skill in the art including online purchases and instore purchases.

Once the purchase order has been placed, the customer in step 202 installs and implements a customer application on a smartphone type device. The customer application enables the customer to interface with the specific drive-through facility where the customer will fulfill the purchase order and pick-up the purchased goods or services.

Once the customer application has been installed and implemented on the customer's smartphone device, the customer application in step 203 prompts the customer for a username and password combination that will be used authenticate the customer onto the drive-through merchandise pick-up system. The customer username and password are generated and stored on. the data system at some point after the purchase order has been placed.

Once the customer has entered their username and password, the customer application. In step 204 establishes wireless communication with the communication system and transits the entered username and password to central server for authentication. If the central server is not able to authenticate the entered username and password, the customer is prompted by the customer application to re-enter their username and password.

Once the customer has been authenticated and after a pre-determined period has passed since the purchase order was places, the customer in step 205 travels to the specific drive-through facility to fulfill one or more particular purchase orders. The customer travels to the drive-through facility with the smartphone type device on which is implemented the customer application and which has been authenticate by the central server.

Once the customer comes within pre-defined range of the drive-through facility, the customer application in step 206 announces his proximity to the drive-through facility. As described above, this may be accomplished using any means know to one of reasonable skill in the art including a low energy beacon device capable of detecting the presence of the customer's authenticated smartphone type device that comes within its range, GPS implemented on the customer's smartphone type device, and a license plate scanning device positioned at or near the entrance of the drive-through facility. Any one or more of these detection means may be used individually or in combination with each other to determine the presence of the customer at a specific drive-through facility. Alternatively, the customer may manually announce his presence at a specific drive-through facility using the customer application implemented on the smartphone type device.

Once the presence of an authenticate customer has been detected by the detection system, the customer application in step 207 receives a confirmation signal transmitted by the communication system under the control of the central server.

The customer application then in step 208 transmits relevant customer and purchase order information to the communication system of the drive-through facility, the relevant customer information including any relevant information including customer identification, purchase order number and original location of purchase order transaction. This information may be entered manually by the customer or retrieved from the data system. This information may he used to check the status of a purchase order to help determine when a customer should travel to the drive-through facility to pick-up the, corresponding goods or services as well as to determine which of the corresponding goods or services are actually ready for pick-up at the drive-through facility.

Once relevant customer and purchase order information has been transmitted to the communication system, the customer application in step 209 receives customer specific and personalized pick-up instructions transmitted from the specific drive-through facility. These customer specific and personalized instructions may include such information as where to physically pick-up the goods or services corresponding to the purchase order, the name of an employee at the drive-through facility that has been assigned to that customer's purchase order, the amount of time until the order will be ready for pick-up, any problems in fulfilling the corresponding goods or services and any possible alternatives to an existing order which cannot be immediately fulfilled. The retail application generates this data using data retrieved from the data system that is relevant to that customer's purchase order as well as warehousing, availability, transportation or any other information relevant to the processing and delivery of the corresponding goods and services.

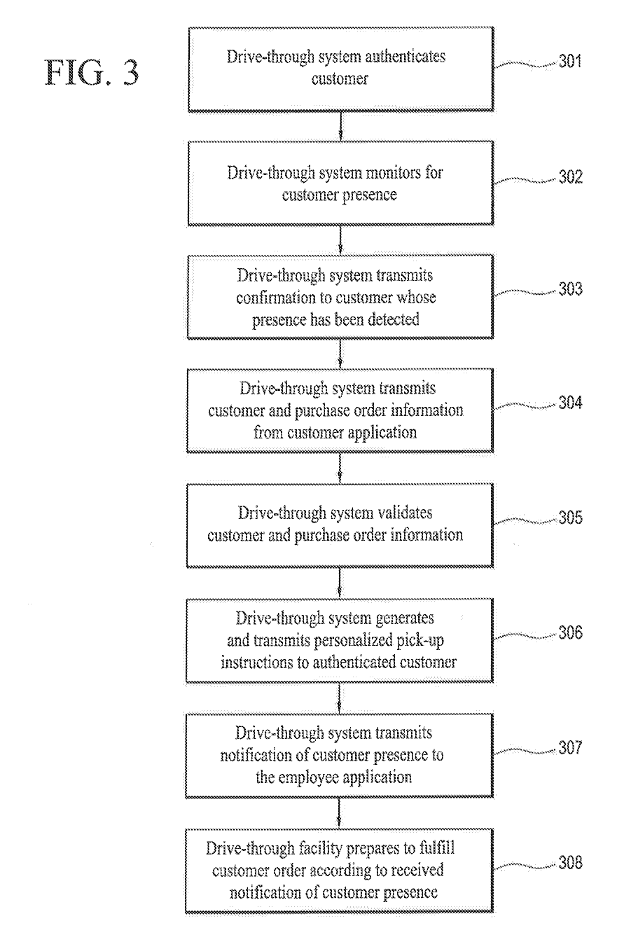

In FIG. 3, a flowchart depicting a retailer centric process implemented on the drive-through merchandise pick-up system according to an exemplary embodiment is depicted. As shown in FIG. 3, the retailer centric process is initiated in step 301 with the authentication of a customer. As discussed above, a customer is authenticated using username and password. Combination type information that is entered into the customer application implemented on a customer's smartphone type device. The customer application communicates with the retail application implemented on the central server to facilitate the authentication based on the entered username and password combination. The smartphone type device communicates with the retail application implemented on the central server via the communication system. The central server accesses the data system where all customer and order information have been stored and are continuously updated.

Once the customer has been authenticated, the drive-through merchandise pick-up system in step 302 monitors the authenticated customer to determine if and when they have come within a pre-defined range of the drive-through facility. A.8 discussed above, any means know to one of reasonable skill in the art may be used to monitor a customer's proximity to the drive-through facility including a low energy beacon device capable of detecting the presence of the smartphone type device that comes within the pre-defined range, CIPS implemented on the smartphone type device, and a license plate scanning device positioned at or near the entrance of the drive-through facility. Any one or more of these communication means may be used individually or in combination to determine the presence of a customer coming to fulfill an order at the drive-through facility. Alternatively, the customer may manually announce their presence at the drive-through facility by directly interfacing with the customer application on the smartphone type device. Moreover, each of these means provides for the transfer of data to and from the central server where incoming data may be processed by the retail application and where the retail application may generate data to be transmitted to the customer application.

The system continuously monitors for smartphone type devices which come within the pre-defined range of the drive-through facility. Once the detection system determines that an authenticated customer has come within range of the drive-through facility, the pick-up system in step 303 transmits a confirmation signal to the customer application implemented on the authenticated customer's smartphone type device. This confirmation signal effectively confirms that the customer has been checked into the drive-through facility and that preparation of the customer's purchase order has begun. The local transmission of data between the drive-through facility and the smartphone type device is accomplished via communication system and may include using any means know to one of reasonable skill in the art include a low power transmission protocol such as Bluetooth, a local wireless network connection or an Internet based connection.

Once the customer application has received confirmation from the drive-through facility via the communication system, the drive-through facility in step 304 receives customer and purchase order information transmitted by the customer application implemented on the customer's smartphone type device. This information may include any data relevant to the fulfillment of the customer's order including customer identification information, order number and date information and the physical location of where the order purchase transaction occurred.

After receiving customer and purchase order information from the customer application, the retail application implemented on the central server in step 305 confirms the customer's order using information retrieved from the data system.

Once the retailer application has confirmed the customer's order, the retail application in step 306 generates and transmits personalized pick-up instructions to the customer. The personalized pick-up instructions may include such information as where to physically pick-up an order, the name of the drive-through facility employee assigned to the purchase order, the amount of time until the order is ready for pick-up, any problems in fulfilling the good or services corresponding to the purchase order and any possible alternatives to the good and services corresponding to that purchase order which cannot be immediately fulfilled at the drive-through facility.

Once personalized instructions have been generated and transmitted to the customer application, the retailer application in step 307 transmits a notification to the employee application implemented on the computing device of the assigned drive-through facility employee. In response to the notification, the employee application appends the purchase order's pick-up information to the end of the employee's electronic work queue. The appended pick-up information may include the specifics of the purchase order, the customer's estimated arrival time at the drive-through facility, the actual arrival time of the customer at the drive-through facility and a notification that the customer has arrived at the drive-through facility.

Lastly, the employee assigned to the customer in step 308 begins gathering goods and services and generating any paperwork needed to fulfill the purchase order in preparation for the customer to arrival at the drive-through facility. The employee performs these task prior to the customer's physical arrival at the drive-through facility and with prior knowledge of the customer's current waiting time and estimated arrival time.

The employee application is able to monitor the progress made in the fulfillment of the assigned customer's purchase order and to present relevant performance data to the employee. Specifically, the employee application is able to calculate and present data on an assigned customer's waiting time, namely the difference between the current time and the customer's actual arrival time. With this information, an employee has the ability to prioritize a customer within their work queue based on their waiting time.

The employee application may further track each customer's fulfillment time, delivery time, the payment time and entire process time. The fulfillment time is the time it takes an employee to gather those products included in a purchase order. The delivery time is the time it takes an employee to physically deliver the products to the customer at the drive-through facility location. The payment time is the time it takes to validate a customer's payment method. The entire time being the culmination of all the times, namely the waiting time, the fulfillment time, the delivery time, and the payment time.

All this information can be used to provide the retailer with relevant statistics on the operation of a drive-through facility. Moreover, all this data may be saved to the data system and analyzed over time along with other customer data and product data also saved to the data system to develop a comprehensive analysis of one or more drive-through facilities across varying data views.

As an additional feature of the exemplary embodiment, once a customer has checked into a drive-through facility, the customer application may launch a game on the smartphone type device to help complement the customer's waiting time. Moreover, the customer application may also display targeted advertisements on the smartphone type device during the waiting time. The type of targeted advertisement displayed on the customer's smartphone type device may be defined by an analysis of the customers passed purchases using data stored on the data system or gathered from other outside sources.

What is claimed:

1. A drive-through type pick-up system comprising:
a physical drive-through type facility for storing supplier or reseller goods that are scheduled to be picked-up by a customer with a corresponding purchase order;
a detection system capable of detecting when the customer is within a pre-defined range of the physical drive-through type facility and of transmitting notification that the customer has been detected within the pre-defined range;
a data system capable of storing and retrieving customer data, purchase order data and drive-through facility performance data; and
a communication system capable of providing for communication between an employee of the drive-thought facility and the detected customer and of providing for a flow of data to and from the data system.

2. The drive-through type pick-up system of claim 1, wherein the communication system includes any one or any combination of a low energy beacon device, a global positioning system and a license plate scanning device.

3. The drive-through type pick-up system of claim 1, further comprising
a smartphone type device accompanying the customer, the smartphone type device implementing a customer application which enables remote communication between the customer and the communication system and
a computing type device accompanying the employee, the computing type device implementing an employee application that enables communication between the employee and the communication system.

4. The drive-through type pick-up system of claim 3, wherein the detection system estimates an arrival time for the customer detected to be within the pre-defined range of the physical drive-through type facility and the communication system providing the arrival time for the customer to the employee.

5. The drive-through type pick-up system of claim 4, wherein the detection system calculates a waiting time for the customer detected to be within the pre-defined range of the physical drive-through type facility, the waiting time calculated as a time difference between a current time and the estimated arrival time.

6. The drive-through type pick-up system of claim 5, wherein the employee application prioritizes customers within a customer queue displayed on the employee computing device based on the calculated waiting time.

7. The drive-through type pick-up system of claim 3, wherein the customer application receives and displays personalized pick-up instructions for the detected customer generated by the central server using data retrieved for the data system and transmitted to the smartphone device by the communication system.

8. The drive-through type pick-up system of claim 3, wherein the customer application provides for a customer to manually announce their presence to the detection system.

9. The drive-through type pick-up system of claim 3, wherein the customer application transits to the communication system identification information and purchase order information inputted by the detected customer.
